(19) United States
(12) Patent Application Publication
(10) Pub. No.: US 2014/0009677 A1
(43) Pub. Date: Jan. 9, 2014

(54) CAPTION EXTRACTION AND ANALYSIS

(71) Applicant: Caption Colorado LLC, Greenwood Village, CO (US)

(72) Inventors: Michael W. Homyack, Highlands Ranch, CO (US); Richard T. Polumbus, Castle Rock, CO (US)

(21) Appl. No.: 13/937,966

(22) Filed: Jul. 9, 2013

Related U.S. Application Data
(60) Provisional application No. 61/669,536, filed on Jul. 9, 2012.

(51) Int. Cl. H04N 5/445

(52) U.S. Cl. CPC H04N 5/445
USPC 348/468

(57) ABSTRACT

Methods and systems are disclosed for caption extraction and analysis. In one such example method, a caption transcript corresponding to a media program is received at an extraction and analysis module, and the caption transcript is divided into one or more segments. Data, words, or phrases are extracted from the one or more segments of the caption transcript, and metadata based on said extracting is provided. The metadata is stored in a metadata archive, where the metadata is associated with the caption transcript.

### CROSS-REFERENCE TO RELATED APPLICATIONS

This application claims the benefit of and priority to U.S. provisional patent application No. 61/669,536, filed on Jul. 9, 2012, and entitled “Caption Extraction and Analysis,” which is hereby incorporated by reference in its entirety for all purposes.

### TECHNICAL FIELD

The technology described herein relates to caption extraction and analysis, and more specifically to systems and methods for utilizing metadata generated in response to caption extraction and analysis.

### BACKGROUND

Closed-captioning of television, radio, Internet, and other media programs is often provided in order for people with hearing impairments to understand the dialogue in a program. Live broadcasts—such as news programs, award shows, and sporting events—are frequently captioned in real time by transcriptionists or captioners watching a feed of the program and/or listening to an audio feed for the program (such as via a telephone or voice over Internet protocol connection) which may be a period of time (such as 4-6 seconds) ahead of the actual live broadcast. In other cases media programs, such as major movie releases, may be captioned “offline.”

The captions from media programs may be used as searchable transcripts to help users find relevant content. For example, a year long collection of caption transcripts from a daily newscast can be searched for information about a current event (e.g., a natural disaster, a political election, etc.). However, such searching can be unwieldy for a number of reasons. For example, during a single newscast, dozens of different topics can be presented, and a search “hit” for a particular newscast's transcript may require a user to look through several irrelevant news stories before finding the news story of interest. As another example, a search for a particular search term may return many results that, though including the search term, are not particularly relevant to what the user was looking for (e.g., a search for “nuggets” may return results for chicken nuggets rather than a professional basketball team the user may be interested in). Furthermore, a user may miss entire newscasts if the terminology used in the newscast does not exactly match the search term used (e.g., a search for “intellectual property” may not return stories that specifically address patents, copyrights, and so forth).

The caption transcripts may also be difficult to search because, for example, they may be in a format (e.g., plain text file, or caption format file) that is not amenable to quick and efficient searching, and may not include information designed to enhance a user's experience while viewing a particular media program.

### BRIEF DESCRIPTION OF THE DRAWINGS

FIG. 1 is a block diagram of caption extraction and analysis system.

FIG. 2 is a flow diagram of a method for generating and using information provided by the caption extraction and analysis system shown in FIG. 1.

FIG. 3 is a flow diagram of another method for generating and using information provided by the caption extraction and analysis system shown in FIG. 1.

FIG. 4 is a table listing information that may be extracted from a caption transcript using the caption extraction and analysis system shown in FIG. 1

FIG. 5 is a flow diagram of a method for extracting key phrases from a caption transcript using the caption extraction and analysis system shown in FIG. 1.

FIG. 6 is a table listing key phrases extracted from a caption transcript using the method shown in FIG. 5.

FIG. 7 is a screenshot of a computer implemented program for presenting information generated by the caption extraction and analysis system shown in FIG. 1.

### DETAILED DESCRIPTION

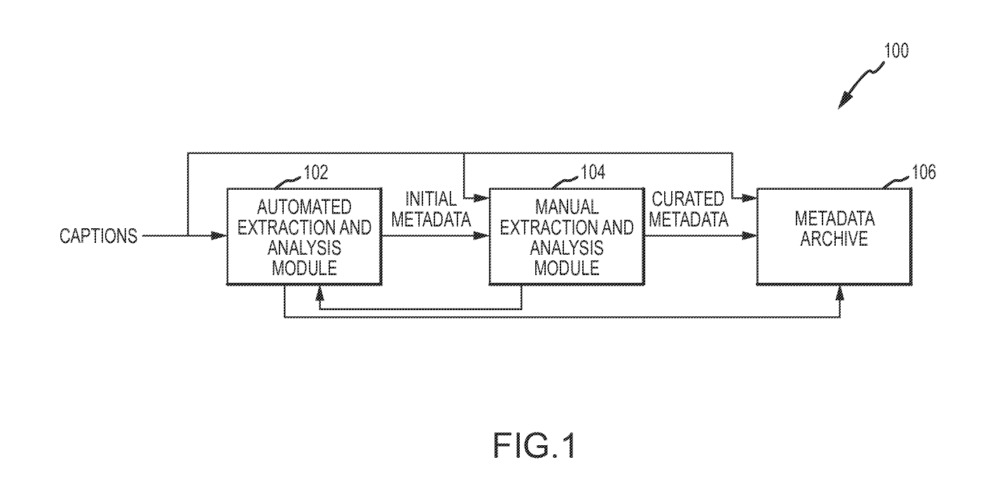

FIG. 1 illustrates an embodiment of a caption extraction and analysis system 100. The caption extraction and analysis system 100 may include an automated extraction and analysis module 102 and/or a manual extraction and analysis module 104, as described in more detail below. The caption extraction and analysis system 100 may also include a metadata archive 106 that may be used for searching for relevant media programs.

As illustrated in FIG. 1, captions may be provided to the automated extraction and analysis module 102 in the form of caption transcripts. In some embodiments, however, no automated extraction and analysis module 102 may be present, and in these embodiments, the caption transcripts may be provided to the manual extraction and analysis module 104. In still other embodiments, no manual extraction and analysis module 104 may be present, and in these embodiments, metadata (described in more detail below) may be provided from the automated extraction and analysis module 102 to a metadata archive 106. For convenience and clarity of description, the present disclosure will describe a caption extraction and analysis system 100 with both an automated extraction and analysis module 102 and a manual extraction and analysis module, although it is contemplated that a caption extraction and analysis system 100 may include only one or the other.

Returning to FIG. 1, initial metadata may be provided from the automated extraction and analysis module 102 to the manual extraction and analysis module 104. Furthermore, in some embodiments, caption transcript(s) may be provided to the manual extraction and analysis module 104. The initial metadata from the automated extraction and analysis module 102 and/or the curated metadata from the manual extraction and analysis module 104 may be provided to the metadata archive 106, and in some embodiments, the caption transcript(s) may also be provided to the metadata archive 106.

The caption transcripts provided to the automated extraction and analysis module 102 and/or to the manual extraction and analysis module 104 may be “synced” or “unsynced.” Synced caption transcripts may be provided by a synchronization system, such as that described for example in U.S. patent application Ser. No. 12/886,769 filed on Sep. 21, 2010 and entitled “Caption and/or Metadata Synchronization for Replay of Previously or Simultaneously Recorded Live Programs,” the entire contents of which are hereby incorporated by reference herein for all purposes. The caption transcript(s) may be synced to a media program, for example, in that the text of the caption transcript(s) is synchronized to the speech that is uttered in a corresponding media program. In other embodiments, however, the caption transcript(s) may not be synced. For example, in some embodiments, the corresponding media program may not immediately be available for syncing the caption transcripts to, and the caption transcripts may therefore be provided to the automated extraction and analysis module 102 and/or to the manual extraction and analysis module 104 in an unsynced format.

The caption transcript(s) provided to the automated extraction and analysis module 102 and/or to the manual extraction and analysis module 104 may in some cases include metadata or metatags embedded within or appended to the caption transcript, as described for example in U.S. patent application Ser. No. 12/429,808 filed on Apr. 24, 2009 and entitled “Metatagging of Captions,” the entire contents of which are hereby incorporated by reference herein for all purposes.

The automated extraction and analysis module 102 and/or the manual extraction and analysis module 104 may, based on the caption transcripts, divide a media program or the corresponding caption transcript(s) into one or more segments termed “clips” or “stories.” For example, a news program may be divided into segments corresponding to different news stories, a sports game may be divided along quarters or halves of playing time, a movie may be divided by chapters, and so forth. The automated extraction and analysis module 102 and/or the manual extraction and analysis module 104 may create or edit metadata based on individual clips or stories, and/or may create or edit metadata based on entire media programs. For example, the automated extraction and analysis module 102 and/or the manual extraction and analysis module 104 may provide metadata corresponding to an entire newscast and/or may provide metadata corresponding to each of the individual stories within the newscast. The metadata corresponding to each of the individual stories within the newscast may be useful when the metadata archive 106 is searched for a news story because a search hit may be easier/quicker to find and may be more direct in that the search hit is for an individual story rather than an entire newscast. However, in some embodiments, it may be useful to have metadata provided that corresponds to an entire media program, and as such, the automated extraction and analysis module 102 and/or the manual extraction and analysis module 104 may provide such in addition to or in place of metadata corresponding to each of the individual clips or stories of a media program.

The division of the media program or the corresponding caption transcripts into one or more segments may be accomplished in several different fashions. For example, the caption transcript file for a specific media program may be divided into one or more subset caption transcript files corresponding to each of the clips or stories, and as explained below metadata may be provided for each of the divided files. Alternatively, or in addition to this, the original, complete transcript file may be retained, and a plurality of sets of metadata may be provided for the complete transcript file—for example, one set of metadata corresponding to the complete transcript file, and one set of metadata corresponding to each of the individual clips or stories within the complete transcript file.

The division of the media program or the corresponding caption transcript(s) into one or more segments by the automated extraction and analysis module 102 and/or the manual extraction and analysis module 104 (as well as the extraction and analysis described in more detail below) may be an iterative process. For example, the automated extraction and analysis module 102 may preliminarily divide a media program or corresponding transcript into one or more clips or stories, but may, after additional processing (as described in more detail below), change the division of the media program or corresponding transcript. Also, a user may, using the manual extraction and analysis module 104, manually change the preliminary division of the media program or corresponding transcript provided by the automated extraction and analysis module 102. For example, the automated extraction and analysis module 102 may preliminarily divide a media program or transcript into five different clips or stories, but a user reviewing the division may, using the manual extraction and analysis module 104, re-combine two of the clips or stories so that there are only four total clips or stories.

Also, although FIG. 1 illustrates the automated extraction and analysis module providing the initial metadata (including the clip or story breaks), in some embodiments, a user may, using the manual extraction and analysis module 104, manually divide a media program or corresponding transcript into the appropriate clips or stories before the media program or corresponding transcript is processed by the automated extraction and analysis module 102.

Furthermore, in some embodiments, metadata or metatags embedded within or appended to a media file or corresponding transcript may provide breaks for the division of the media file or corresponding transcript into one or more clips or stories. For example, if a football game includes metadata or metatags indicating the different quarters of the football game, the automated extraction and analysis module 102 and/or the manual extraction and analysis module 104 may use the metadata or metatags in dividing the media program or corresponding transcript.

Returning to FIG. 1, the automated extraction and analysis module 102 and/or the manual extraction and analysis module 104 may extract information such as data, words, phrases and so forth out of a caption transcript corresponding to a media program and/or individual clips or stories, and may analyze the content of the caption transcript (and in some embodiments, any relevant metadata or metatags) and/or individual clips or stories to provide metadata to be stored in the metadata archive 106 illustrated in FIG. 1.

Referring to the automated extraction and analysis module 102, in some embodiments an automated text mining or semantic analysis program may extract data, words and so forth from the caption transcript of a media program and/or from individual clips or stories, and may analyze the content of the corresponding transcript(s). One example of a text mining and semantic analysis program is AlchemyAPI™. Of course, many other suitable text mining and/or semantic analysis programs may be used in generating the metadata stored in the metadata archive 106 illustrated in FIG. 1. With reference to “extraction,” the automated extraction and analysis module 102 may extract one or more places (e.g., city, state, country, etc.), entities (e.g., companies, industries, etc.), languages, people (e.g., individuals, celebrities, career types, etc.) events (e.g., natural disasters, historical events, etc.) mentioned or referred to in the caption transcript corresponding to either the entire media program and/or to individual clips or stories of the media program. With reference to “analysis,” the automated extraction and analysis module 102 may provide one or more keywords, abstract ideas, concepts, and so forth based on to the caption transcript(s). In some embodiments, the keywords, abstract ideas, concepts, and the like may not be explicitly referenced in the caption transcript(s), but may be provided by the automated extraction and analysis module 102 based on the caption transcript. For example, if a caption transcript describes a mardi gras party, the automated extraction and analysis module 102 may provide a keyword such as “New Orleans,” even though neither New Orleans or Louisiana are ever explicitly referenced in the caption transcript.

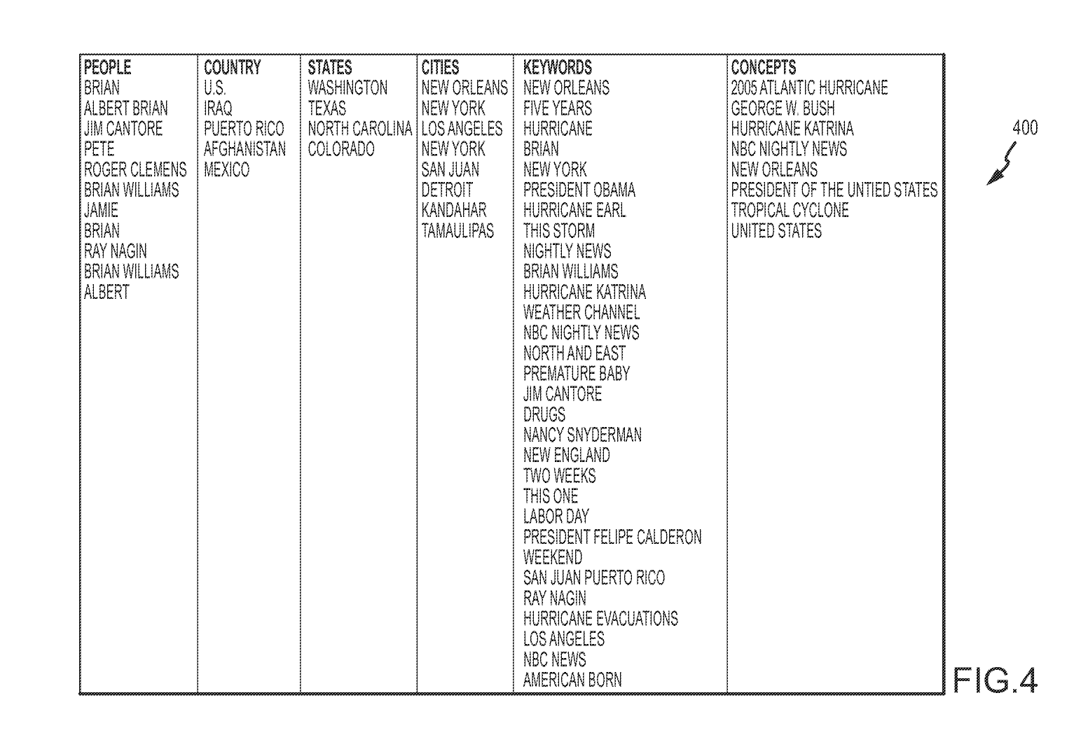

As described in more detail below with reference to FIG. 4, the result of the extraction and analysis of the caption transcripts may be provided as a series of lists in each of a plurality of categories. For example, the extraction and analysis may return a list of people mentioned in the transcript, a list of places (cities, states, countries, etc.) a list of keywords, a list of concepts, etc. This information may in turn be stored as metadata associated with a caption transcript and/or program.

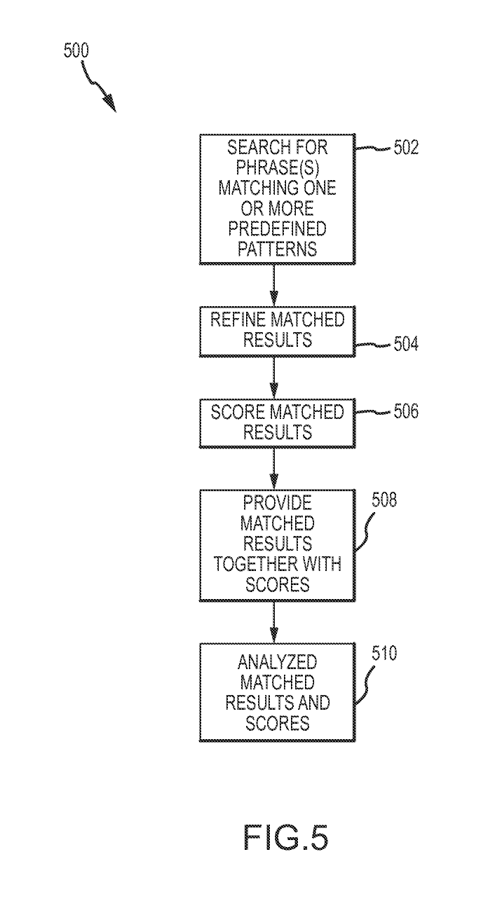

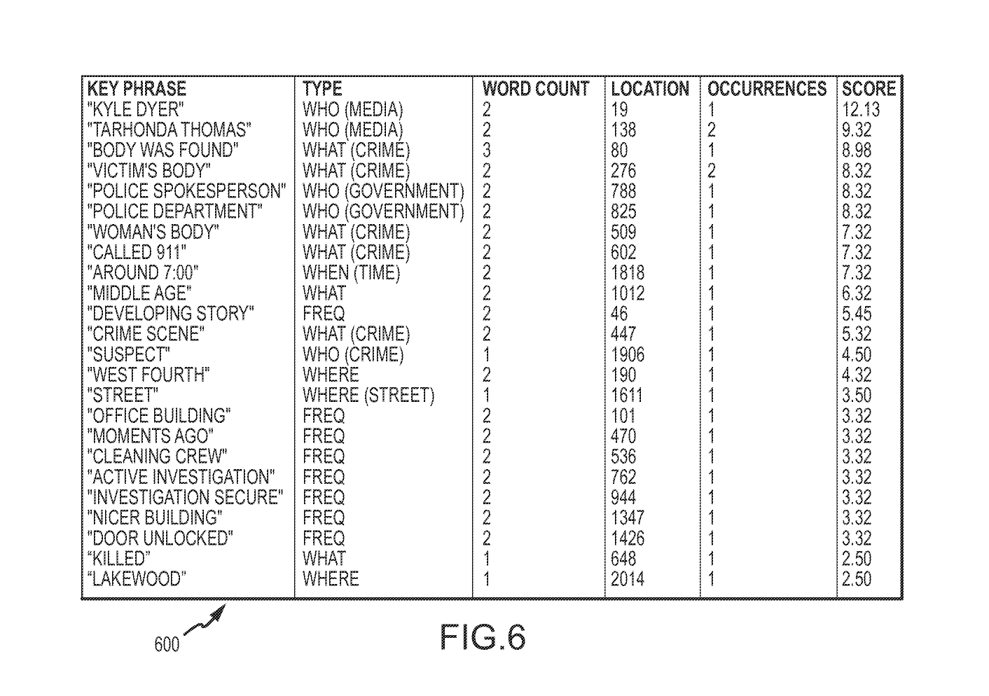

Also as described in more detail below, with reference for example to FIGS. 5 and 6, many different other methods may be used to extract data from and/or analyze a caption transcript. These methods include automated methods (e.g., done in automated extraction and analysis module 102), manual methods (e.g., done in manual extraction and analysis module 104), and hybrid combinations of both methods.

As mentioned, the automated extraction and analysis module 102 may process an entire media program or its corresponding caption transcript in some embodiments, and/or may process individual clips or stories from a media program or corresponding transcript(s). Processing the entire media program or corresponding transcript may provide a higher-level view, and may provide more general information. Processing individual clips or stories, on the other hand, may provide more focused information, and may provide a closer examination of the clip or story. As mentioned, either or both of the entire media program or the individual clips or stories may be processed by the automated extraction and analysis module 102 and/or the manual extraction and analysis module 104.

The automated extraction and analysis module 102 may also or alternatively provide a concept map for a media program and/or for individual clips or stories. The concept map may include a timeline of concepts or key ideas discussed or described in the media program and/or the individual clips or stories. For example, if the media program is a recorded lecture, the concept map may generally follow the broad themes of the lecture. The concept map may include time or location references to the media program and/or to the corresponding caption transcript. For example, the concept map may include a reference that the first major topic is discussed from 0:0:0 to 0:15:30 in the media program, and that the second major topic is discussed from 0:15:31 to 0:26:15 in the media program. In some embodiments, the concept map may also refer to sub-topics discussed in the media program, or may include both broad concept topics and more narrow specific topics.

The automated extraction and analysis module 102 may further perform many different types of extraction and analysis on a media program or individual clips or stories. For example, the automated extraction and analysis module 102 may analyze the vocabulary and sentence structure and determine an intended audience for the media program or clip or story (e.g., children vs. adults), may determine a sentiment or mood of the speaker (e.g., positive outlook, negative resentment, etc.), may determine whether a media program or clip or story contains a specific type of information (e.g., confidential information), and so on and so forth. In general, the automated extraction and analysis module 102 may perform many different types of extraction and/or analysis.

In response to the extraction and/or analysis done by the automated extraction and analysis module 102 (and/or the manual extraction and analysis module 104), a set of metadata may be provided. The metadata may be one or more suitable formats, such as Extensible Markup Language (XML), JavaScript Object Notation (JSON), Resource Description Framework (RDF), and so forth. As described below, the metadata may be stored in a metadata archive 106 in any of a number of different formats, and may correspond to an entire media program, one or more individual clips or stories, or both.

Returning to FIG. 1, and as mentioned above, a manual extraction and analysis module 104 may be provided in addition to, or in place of an automated extraction and analysis module 102. Generally, the manual extraction and analysis module may be similar to the automated extraction and analysis module 102 and may include similar functionality, except that most or all of the determinations may be made manually by a user. For example, as noted above, the user may override the automated division of a media program into different clips or stories, or the user may divide a media program into different clips or stories first before the automated extraction and analysis module 102 processes the media program at all. The user may also in some embodiments review at least portions of the initial metadata provided by the automated extraction and analysis module 102 for correctness. For example, the user may review the keywords, phrases, and concepts for a particular clip or story to verify that no keywords, phrases, or concepts were omitted and/or to verify that all relevant keywords, phrases and concepts are included. When a user utilizes the manual extraction and analysis module 104 to improve the initial metadata provided by the manual extraction and analysis module 104, the resulting metadata may be called “curated” metadata. Alternatively, in systems without an automated extraction and analysis module 102, the manual extraction and analysis module 104 may be utilized by a user to provide some or all of the relevant data extracted and/or analyzed by the automated extraction and analysis module 102, and the metadata provided by the manual extraction and analysis module 104 may be provided directly to the metadata archive 106. In still other embodiments, specifically systems without a manual extraction and analysis module 104, the initial metadata provided by the automated extraction and analysis module 102 may be provided directly to the metadata archive 106.

The metadata archive 106 may receive the initial metadata, the curated metadata, the caption transcripts, and/or any other suitable information regarding the media program (which, as described above, may already have metadata or metatags associated with it) and corresponding caption transcript, individual clips or media programs and their corresponding caption transcript(s), and so forth. The metadata archive 106 may be programmed according to Structured Query Language (SQL), or any other suitable database protocol. The metadata from the automated extraction and analysis module 102 and/or the manual extraction and analysis module 104 may be stored in the metadata archive 106 alone, or may be associated (e.g., embedded, appended, linked to, etc.) with the corresponding media program, clip or story, or with the corresponding caption transcript. As described in more detail below, the metadata archive 106 may be used to find relevant media programs and/or relevant individual clips and stories, and may also be used for other purposes also described below. In some embodiments, the metadata archive 106 may include or be configured to operate in connection with a computer program or interface in order to allow one or more users to manage the metadata in the archive—for example to view caption transcripts and associated metadata, to edit or revise metadata, to research the metadata and transcripts (e.g., to find monetization ideas), and so forth.

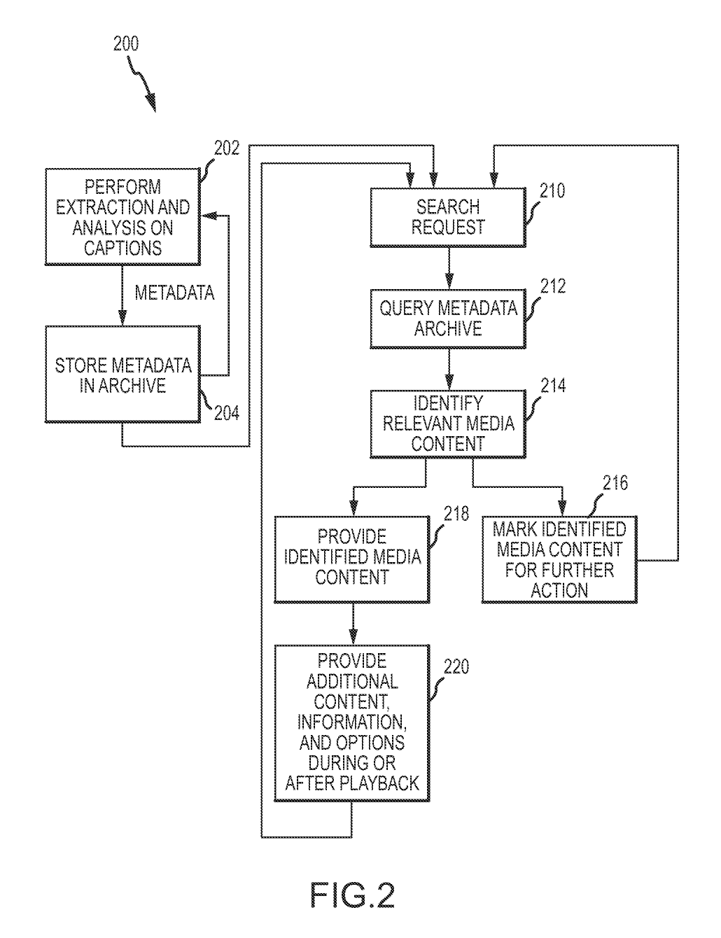

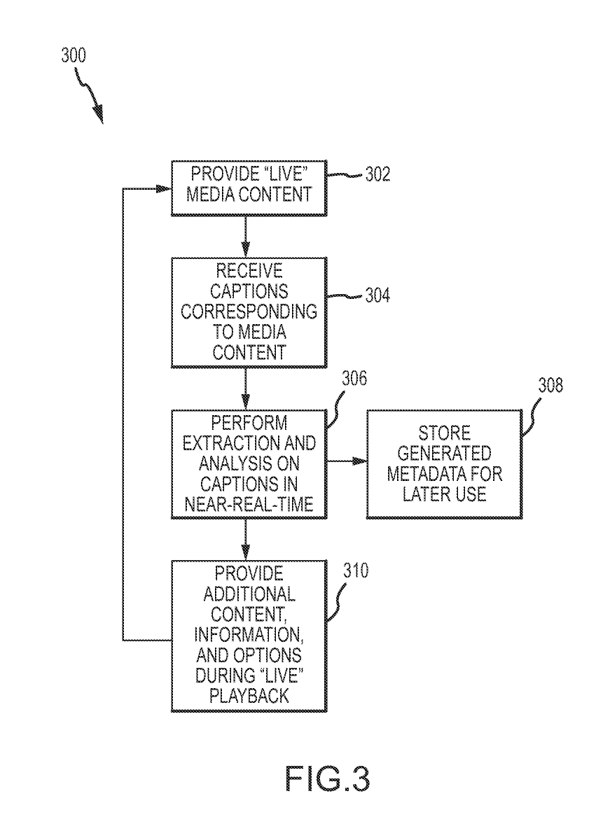

The caption extraction and analysis system 100 shown in FIG. 1 and described herein may be used in near-real-time for “live” media programs, and/or may be used for previously recorded media programs. One embodiment of a method for using the metadata provided by the caption extraction and analysis system 100 shown in FIG. 1 for previously recorded media programs is shown and described with reference to FIG. 2, and one embodiment of a method for using the metadata provided by the caption extraction and analysis system 100 shown in FIG. 1 for live media programs is shown and described with reference to FIG. 3. Of course, many suitable methods may be used in connection with the caption extraction and analysis system 100 shown in FIG. 1, and the methods described with reference to FIGS. 2 and 3 may be used with different embodiments of a caption extraction and analysis system 100.

With reference now to FIG. 2, a method 200 for generating and using the metadata provided by the caption extraction and analysis system 100 shown in FIG. 1 will now be described. In a first operation 202, caption transcripts are provided to the automated extraction and analysis module 102 and/or to the manual extraction and analysis module 104, and in operation 204, the metadata provided in response is stored in the metadata archive 106. Operations 202 and 204 may be performed for each relevant media program and/or each individual clip or story of media program(s) for which a user desires to store associated metadata in the metadata archive 106 for subsequent searching. In some cases, operations 202 and 204 may be performed for a collection of caption transcripts, whereas in other cases operations 202 and 204 may be performed for individual caption transcripts shortly after a corresponding media program is completed, or even during an ongoing media program.

In operation 210 a search request may be made. The search request may be made by a person or an entity. For example, an end user of a media service may submit a search request for a video on a natural disaster. Another example of a person who may submit a search request may be a transcriptionist or captioner who is preparing or training to transcribe or caption an audio program—for example, a captioner who is preparing to provide captions for a technical program (e.g., financial planning, legal, etc.) may submit a search request for previous media programs relating to the topic, or previous media programs with similar hosts or speakers, and so forth.

Another example of an entity that may submit a search request is a content provider, such as a news station. The content provider may have years worth of media programs, and associated transcripts, and may be interested in archiving selected portions of the media programs, but not others. For example, a news provider may be interested in archiving news stories regarding political elections, but not be interested in archiving the daily weather or daily performance of financial indices. Submitting a search request may help the news provider cull and identify relevant stories for archival. In general, any different type of person or entity may submit a search request.

In operation 212, in response to the search request, the metadata archive 106 is queried. As described above, the metadata archive 106 may take one of several suitable formats or structures, and the format and structure of the archive 106 may determine how the query is submitted and what is received from the archive 106 in response. For example, if the metadata archive 106 also includes the full text caption transcripts for each of the media programs or individual clips or stories, a query to the metadata archive 106 may query not only the metadata provided by the automated extraction and analysis module 102 and/or the manual extraction and analysis module 104, but may also query the caption transcript(s) as well. Querying the metadata in the metadata archive 106 may provide an advantage over solely querying caption transcripts because the query may take less time to process, may be more accurate and reliable, may return better or more relevant results, and so forth, as mentioned above.

In response to the query to the metadata archive 106 from operation 212, in operation 214 relevant caption transcripts associated with a media program (or clip or story) and/or a media program (or clip or story) itself may be identified to the user or entity submitting the search request. The relevant caption transcripts and/or the relevant media program (or clip or story) may be identified in a playlist or any other suitable presentation that allows the user or entity to review the identified caption transcript, media program, clip or story, or any combination of these.

In operation 216, one or more of the identified caption transcripts or media programs or clips or stories may be marked for further action. For example, an entity desiring to archive select media programs may mark important media programs and/or clips or stories in order to be able to digitize the media programs and/or clips or stories, or in other cases in order to synchronize the caption transcript with the corresponding media program or clip or story.

Alternatively, in operation 218, one or more of the identified caption transcripts or media programs or clips or stories may be provided to a user. For example, a media program or clip or story associated with an identified caption transcript may be provided to the user to view. In some embodiments, such as those in which the caption transcript is synced to a media program or a clip or story, the media program or clip or story may be provided beginning at the relevant time within the media program or clip or story at which a particular topic, keyword, concept, word, and so forth is mentioned in the caption transcript. In other embodiments, whether or not the caption transcript is synced, the media program or clip or story may be provided at the beginning of the media program or clip or story.

During or after playback of the caption transcript or associated media program or clip or story, additional content, information, and/or options may be provided to the user in operation 220. A few examples of additional content, information, and/or options that may be provided include: related media programs (or clips or stories), maps, targeted ads, websites, resources such as online encyclopedias, and so forth. The additional content, information, and/or options may be based on the search request, the metadata archive 106 query, the keywords or concepts associated with the caption transcript or associated media program or clip or story, words spoken or images shown during the associated media program or clip or story, some combination of the above, and so forth. The additional content, information, and/or options may be provided in one or more different formats, including in a sidebar, a pop-up, a list or playlist, a picture, and so forth.

With reference now to FIG. 3, another method 300 for generating and using the metadata provided by the caption extraction and analysis system 100 shown in FIG. 1 will be described. In a first operation 302, “live” media content may be provided. In operation 304, caption transcript(s) corresponding to the media content may be received by the automated extraction and analysis module 102 and/or the manual extraction and analysis module 104. In operation 306, the automated extraction and analysis module 102 and/or the manual extraction and analysis module 104 may perform extraction and analysis of the caption transcript(s) in near-real-time. The metadata generated by the automated extraction and analysis module 102 and/or the manual extraction and analysis module 104 may be stored for later use in operation 308. Furthermore, in operation 310, additional content, information, and options may be provided during live playback of the media content, as described above in connection with previously recorded media programs.

As mentioned above and with reference now to FIG. 4, the extraction of information from and analysis of caption data in operations 202 and/or 306 may provide any of a number of different outputs. For example, FIG. 4 shows a table with different categories, and a list of people, places, keywords, and concepts gleaned from a particular caption using a text mining or semantic analysis program.

Referring now to FIG. 5 in some embodiments, a key phrase extraction method 500 may be used in operations 202 and/or 306 in order to obtain metadata corresponding to a caption transcript. The method 500 illustrated in FIG. 5 may be similar to a data mining or semantic analysis program used to generate the data shown in FIG. 4, but the method 500 illustrated in FIG. 5 may be more custom tailored to identify relevant key phrases from typical caption transcripts. It will be appreciated that a “phrase” as used herein, includes constructs of a single word (i.e. one word phrases) as well as constructs of a plurality of words (i.e. multiple word phrases).

In operation 502, a caption transcript may be searched for one or more phrases matching one or more predefined patterns. The predefined patterns may be established before operation 502 begins, and may be established based on any of a number of factors.

The predefined patterns may include one or more types of patterns. One type of pattern may be a simple list of words and phrases—for example nouns and proper nouns. Another type of pattern may be a regular expression. For example, one regular expression pattern may include the word “Lake” followed by any of a plurality of different lake names. As another example of a regular expression pattern, variations on a single word (both “color” and “colour”) may be encompassed by a pattern. Still other regular expressions may be designed in order to capture phrases that are common in spoken or written language for a particular type of media clip. For example, the words “charged with” may be particularly relevant in the context of news programs covering criminal activity. As such, a regular expression that takes a name or pronoun, followed by “charged with,” followed by one of a list of different crimes (murder, robbery, assault, etc.) may form a regular expression pattern. These types of regular expressions may be automatically generated and/or may be manually created by a system operator who has familiarity with different phrases used in different contexts.

Another type of pattern may include an “exploded” term—which may be multiple variations on a word that all nonetheless may refer to the same thing. For example, Edward may be exploded to include Ed, Eddy, Eddie, Ted, Teddy, Ned, and so forth, or Katherine may be exploded to include Kathy, Kat, Katie, Katy, Kit, Kitty, Kate, and so forth.

Still another type of pattern may be based on strings of words that do not include one or more particular words, or in other words that searches for consecutive, non-trivial words. This type of pattern may be termed FREQ (for frequency), and may be used to extract phrases with 2 or more consecutive words that do not have any of a list of “stop words” intervening in the phrase. “Stop words” may be trivial words that have little to no probative value, such as of, the, in, a for, who, which, he, she, 1, 2, 3, 4, . . . , as well as other ambiguous terms. A FREQ pattern thus may match phrases that have consecutive words without any of these low value terms in the phrase.

Many other types of semantic-based, vocabulary-based, or experience-based patterns may similarly be used.

The predefined patterns may in some embodiments be categorized. Each predefined pattern may for example be associated with a primary category, and may optionally also be associated with one or more sub-categories. Primary categories may include for example phrases that answer the questions WHO (individual people, named groups, ethnicity, nationality, etc.), WHAT (action phrase, physical things, etc.), WHERE (city, state, country, other proper nouns designating locations, geographic features, regions, etc.), WHEN (date, time, holiday, season, etc.), and so forth. Other categories may include contact information (URL, phone number, address, etc.). Some categories may be defined based on the type of pattern used to detect a phrase—for example the FREQ patterns may all share a FREQ category. Other categories and/or subcategories may be subject matter based—for example crime, sports, business, politics, etc. In some examples, a pattern may be associated with a single category and/or subcategory, whereas in other embodiments, each pattern may be associated with a plurality of different categories and/or subcategories.

Returning to operation 502, the caption transcript may be searched for the one or more patterns in any of a variety of ways. For example, a comparison program may be used to try to find each and every predefined pattern in a plurality of subsets of the caption transcript. In other examples, a heuristic may be used to intelligently search for the one or more predefined patterns. Operation 502 may produce one or more matched results, which are phrases within the caption transcript that matched one or more patterns. The matched results generated in operation 502 may also include information about the pattern against which the phrase was matched, the location of the phrase within the caption transcript, whether the phrase appears more than once in the caption transcript, the categories/subcategories associated with the pattern against which the phrase was matched, and so forth.

This additional information, as well as the matched results themselves, may be used in operation 504 to help refine the matched results in some embodiments using, for example, the manual extraction and analysis module 102 described above. Certain matched results may be removed from the result list or combined with other results if, for example, they are repetitive or closely similar to other matched results. For example, the phrase “4th of July” may be combined with the phrase “Independence Day,” both of which may be categorized as a time, and more specifically as a holiday. Furthermore, in operation 504 one or more matched results may be removed depending on the categories associated with the matched results. For example, if many or most of the matched results are categorized under crime, but one matched result is categorized as a restaurant, then the matched result associated with the restaurant category may be disregarded as perhaps not centrally relevant to the story at hand.

In operation 506, each of the (remaining) matched results is scored. The score given to each of the matched results may take into consideration one or more of a plurality of factors, and may indicate the possible relevance of the matched phrase. The score may be used, for example, to sort the matched results from a single transcript in order to identify the “most relevant” phrases from the caption transcript.

The score of a matched result may be based on one or more of: the (type of) pattern that was matched, the categories/subcategories associated with the pattern that was matched, the complexity of the pattern that was matched, the location where the phrase first appears in the transcript (closer to the beginning of the transcript may indicate greater importance), the length in words or characters of the phrase (longer phrases may indicate greater importance), the presence of absence of certain words or characters, the frequency with which the phrase is used in the transcript (multiple occurrences of a single phrase within a transcript may indicate greater importance), and so forth.

In some embodiments, the score assigned to each of the matched results may vary depending on the type of program embodied in the caption transcript. For example, in a news program, words near certain buzzwords (e.g., developing, urgent, critical, emergency, alert, etc.) may be more important than words away from those buzzwords, and phrases near the beginning of the newscast may be more important than phrases in the middle or end of the newscast. In a sports program, on the other hand, the most important phrases may be located near certain events (touchdown, goal, etc.), or may be located towards the end of the program (overtime, final, commentator analysis following the game, etc.). In a comedy program, the most important phrases may be those that are repeated several times. In general, the scores allocated to the various key phrases found in operation 502 may vary depending on many different factors.

In operation 508, each of the matched results are provided to the system 100, and may be stored in the metadata archive 106 as being associated with a particular caption transcript. In some embodiments, the scores corresponding to each of the matched results is also provided and stored. In some embodiments, all of the matched results are provided or stored, whereas in other embodiments, only certain of the matched results are provided or stored (e.g., the 5 results with the highest relevance scores). As described below, in some embodiments, the most relevant results (e.g., those with the highest scores) may be provided in a list of keywords or phrases to a viewer of a video corresponding to the caption transcript.

In operation 510, the matched results and/or the caption transcript itself may be analyzed. The matched results may be analyzed in order to, for example, categorize the program associated with the caption transcript, or to provide additional information to a user. As just one example, if more than a certain threshold percentage of the matched results are from one category (e.g. Sports—basketball), then that transcript or underlying program may be categorized as a basketball game with a certain level of confidence.

FIG. 6 illustrates a sample listing of key phrases that may be obtained using the method 500 illustrated in FIG. 5 and described herein. The listing shown in the table of FIG. 6 may be obtained from extracting information from and analyzing the following example story:

“Hi, everybody. I'm Kyle Dyer. We start with a developing story from Lakewood. A body was found at an office building. Let's check in with Tarhonda Thomas who joins us live from the scene at West fourth and union. Is that right? Reporter: Yes, we are at fourth and union. That victim's body is still inside the building. Lakewood police are investigating this area. The building is closed. No one that works here can go inside. Let me show you the crime scene from a few moments ago. Police say they found the woman's body last night. A cleaning crew came in the building and they found the woman. They called 911. Police are not saying how she was killed, whether that was a gunshot or any other method. They are keeping a lot of things confidential. This is an active investigation. The police spokesperson for the Lakewood police department says there are a lot of things that only the person did this would know. They are trying to keep the investigation secure. They are saying the victim is a woman. She is Middle age. They are not confirming her identity because the family members don't know what happened. That is the reason why we are getting few details about exactly what is going on. But, word has spread to people that work in this building and they are unneared of about what has happened here. Take a listen. This is something in a nicer building you don't expect to happen. It makes you feel, when you leave a door unlocked for people to come in and out, as they walk in, what could they want or what will they do. Reporter: That is what people are wondering. We have seen them line up down the street asking questions. Police are going in and out of the building. They are getting dressed in their gear. The victim's body is still inside. They say if you saw anything in this area of fourth and union around 7:00 last night give them a call. They think this is a Homicide. There will be a suspect that they will be looking for. If you saw anything, heard anything or think you know anything, give Lakewood police a call. Kyle? All right, Tarhonda Thomas, thanks so much.”

As can be seen in the table of FIG. 6, each of the key phrase matched results includes the text string that matched a pattern in operation 502, along with a type category, a word count for the phrase, a character location within the transcript, the number of occurrences in the transcript, and a score generated for that particular matched result. It will be understood that many variations are possible—for example the length which is shown as word count in FIG. 6 may alternately be calculated as a character count, and the character location shown in FIG. 6 may alternately be a word location. Similarly, as described above, the scores shown in FIG. 6 are merely illustrative of one type of scoring system that may be used.

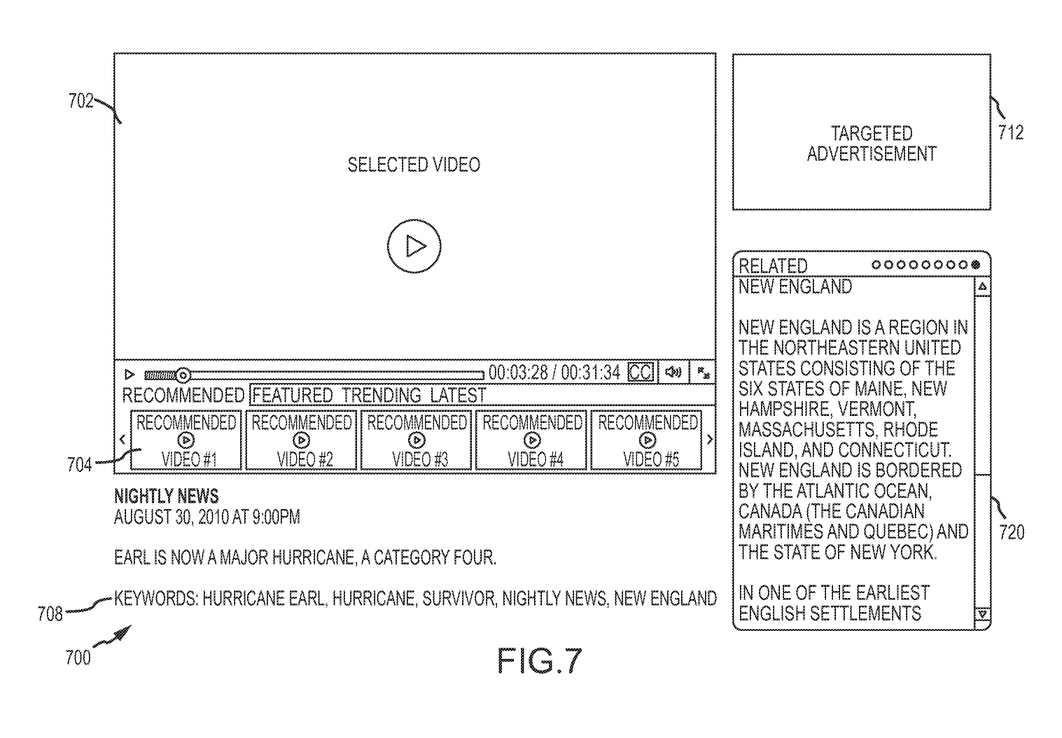

With reference now to FIG. 7, a screenshot 700 of a computer implemented program for using information provided by the caption extraction and analysis system 100 is shown. The screenshot 700 may correspond to one or more of operations 218, 220, 302, 310, and so forth, as described above. For example, the screenshot 700 includes a window 702 in which a selected video may be played. The screenshot 700 also illustrates a plurality of recommended videos 704 which may be presented to a user—and the recommendations may be based on the recommended videos 704 having similar or overlapping key words or phrases as the currently selected video 702. The screenshot 700 also illustrates a listing 708 of keywords or key phrases, which may be the keywords or key phrases extracted from a caption transcript in operations 202, 306, or in any of the operations in method 500. The screenshot 700 also illustrates additional information, such as a targeted advertisement 712 (which may be based on the extracted and analyzed information from the caption transcript of the currently selected video 702 as described above), and an online encyclopedia entry 720 for one of the keywords or key phrases from listing 708. It will be understood that the screenshot 700 shown in FIG. 7 is merely illustrative of some of the options that may be possible using the metadata generated by the caption extraction and analysis system 100 using the methods 200, 300, 500 illustrated and described herein, and that the metadata may be used in many other ways as well.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claim(s) present elements of the various steps in a sample order, and are not necessarily meant to be limited to the specific order or hierarchy presented. Furthermore, in the various methods 200, 300, 500 described herein, some operations may be optional—as just one example, operation 504 may be skipped in method 500 in some embodiments, as may option 510. In general, unless otherwise noted, the operations described herein may be rearranged and/or skipped.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory.

While the present disclosure has been described with reference to several embodiments, these embodiments are illustrative only, and the scope of the disclosure is not limited to them. Many variations, modifications, additions, and improvements are possible. More generally, embodiments in accordance with the present disclosure have been described in the context of particular embodiments. Functionality may be separated or combined in blocks differently in various embodiments of the disclosure or described with different terminology. These and other variations, modifications, additions, and improvements may fall within the scope of the disclosure.

What is claimed is:

1. A method, comprising:
receiving a caption transcript at an extraction and analysis module;
dividing the caption transcript into one or more segments;
extracting data, words, or phrases from the one or more segments of the caption transcript;
providing metadata based on said extracting; and
storing the metadata in a metadata archive, the metadata being associated with the caption transcript in the metadata archive.

2. The method of claim 1, further comprising:
querying the metadata archive to identify relevant media content; and
providing the identified, relevant media content to a user.

3. The method of claim 2, further comprising providing additional content to the user.

4. The method of claim 3, wherein the additional content is provided to the user based on a search term used to query the metadata archive, a keyword associated with the media content provided to the user, or an event in the media content provided to the user.

5. The method of claim 1, further comprising:
analyzing the extract data, words, or phrases, or the caption transcript, to generate additional information; and
storing the additional information in the metadata archive.

6. The method of claim 1, wherein the metadata stored in the metadata archive includes at least some of the extracted data, words, or phrases.

7. The method of claim 6, wherein the metadata includes relevance scores associated with one or more key phrases extracted from the caption transcript.

8. The method of claim 1, wherein the caption transcript corresponds to only a portion of a media program.

9. The method of claim 1, wherein the metadata is provided in substantially real-time relative to a live media program.

10. The method of claim 1, wherein the extraction and analysis module is automated.

11. A system, comprising:
an extraction and analysis module configured to receive a caption transcript corresponding to a media program, divide the caption transcript or media program into one or more segments, extract information from the caption transcript, analyze the caption transcript, and provide metadata based on said extracting and analyzing; and
a metadata archive configured to store metadata provided by the extraction and analysis module.

12. The system of claim 11, wherein the metadata archive is further configured to store the caption transcript.

13. The system of claim 11, wherein the extraction and analysis module is automated and wherein the system further comprises a manual extraction and analysis module.

14. The method of claim 13, wherein the manual extraction and analysis module is configured to edit metadata provided by the automated extraction and analysis module.

15. A method for creating metadata associated with a caption transcript, comprising:
searching a caption transcript for phrases matching one or more predefined patterns;
scoring the matched phrases from the caption transcript as a function of their relevance within the caption transcript; and
storing in a metadata archive at least some of the matched phrases and their corresponding scores as metadata associated with the caption transcript.

16. The method of claim 15, further comprising categorizing the caption transcript as a function of the matched phrases.

17. The method of claim 15, wherein only the most relevant of the matched phrases are stored in the metadata archive.

18. The method of claim 15, wherein at least one of the predefined patterns comprises a regular expression.

19. The method of claim 15, wherein at least one of the matched phrases is not stored in the metadata archive as a result of the at least one matched phrase not being in a similar category as a plurality of others of the matched phrases.

20. The method of claim 15, wherein at least one of the predefined patterns comprises a pattern which searches for consecutive, non-trivial words.
